(19) United States
(12) Patent Application Publication
(10) Pub. No.: US 2011/0068562 A1
(43) Pub. Date: Mar. 24, 2011

(54) Medication cart

(76) Inventors: Mark G. Keffeler, Elkhorn, NE (US); David P. Keffeler, Omaha, NE (US)

(21) Appl. No.: 12/586,230

(22) Filed: Sep. 18, 2009

(51) Int. Cl. B62B 1/00

(52) U.S. Cl. 280/651

(57) ABSTRACT

A medication cart is disclosed for use in a hospital, rest home, nursing home or the like to conveniently deliver medications to patients therein. The medication cart has a plurality of drawers movably mounted in the front portion thereof and has trash receptacles positioned at one side of the cart. The cart also has a receptacle or receptacles positioned at the other side thereof. Upstanding posts are provided at the corners of the cart and have hand gripping portions at the upper ends thereof which permit the cart to be conveniently moved from one location to another. Further, the cart has an auxiliary port tray positioned thereon which may be selectively moved from a vertically disposed stored or stowed position to a horizontally disposed operative position.

### BACKGROUND OF THE INVENTION

1. Field of the Invention

This invention relates to a medication cart and more particularly to a medication cart which may be used in hospitals, rest homes, nursing homes or the like to conveniently deliver medication to patients therein.

2. Description of the Related Art

Medication carts are commonly used in rest homes, nursing homes and hospitals to deliver medications to individual patients located throughout the facility. Applicants believe that the medication carts of the prior art are not easily maneuverable since only a pair of handles are normally provided on opposite sides of the cart. Further, the medication carts of the prior art are not believed to provide sufficient countertop space thereon to enable the efficient dispensing of the medications and preparing the necessary documentation relating to the dispensing of the medications. Further, it is believed that the prior art medication carts do not provide a means for conveniently supporting files in a selectively movable fashion above the countertop portion of the cart.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A medication cart is described which includes an upstanding housing or cabinet having upper and lower ends and which includes a wheeled base, a front portion, a back portion, a right side portion, a left side portion, and a generally horizontally disposed countertop portion. Preferably, the wheels of the base of the cart are caster wheels and have brakes associated therewith. The housing has a first upstanding post at the juncture of the left side portion and the front portion, a second upstanding post at the juncture of the front portion and the right side portion, a third upstanding post at the juncture of the left side portion and the back portion, and a fourth upstanding post at the juncture of the back portion and the left side portion. Each of the first, second, third and fourth posts have upper ends which define hand gripping portions which enable a person to grasp one or two of the gripping portions to maneuver the housing. The front portion of the housing has a plurality of selectively movable medication drawers positioned therein which are slidably movable from a closed position beneath the countertop portion to an open position. The left side portion of the housing has a receptacle support removably secured thereto which includes one or more receptacles therein. The right side portion of the housing has a pair of trash receptacles selectively removably mounted thereon.

A vertically disposed support member is selectively positioned within one of the first, second, third and fourth posts and has a support arm pivotally secured thereto about a vertical axis. The support arm supports a file or computer supporting device thereon so that files or a laptop computer may be movably positioned above the countertop. A tray is selectively movably mounted on the housing and which is movable from a vertically disposed stowed position to a horizontally disposed operative position.

It is therefore a principal object of the invention to provide an improved medication cart.

A further object of the invention is to provide a medication cart which includes upstanding posts at the corners thereof which define hand gripping portions at the upper ends thereof which enable the cart to be easily maneuvered in various directions.

A further object of the invention is to provide a medication cart which includes an auxiliary countertop or tray which is selectively movable between a vertically disposed stowed position to a horizontally disposed operative position.

A further object of the invention is to provide a medication cart which is convenient to use.

A further object of the invention is to provide a medication cart which is aesthetic in appearance.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a left front perspective view of the cart of this invention;

FIG. 2 is a right rear perspective view of the medication cart of this invention;

FIG. 3 is a perspective view of the medication cart of this invention with the optional file support provided thereon;

FIG. 4 is a view similar to FIG. 3 except that the file support is shown to be supporting files thereon;

FIG. 5 is a view similar to FIG. 4 but which shows a laptop computer being positioned on the file support;

FIG. 6 is a top view of the medication cart of this invention;

FIG. 7 is a partial exploded left side view of the medication cart illustrating the manner in which various receptacles may be mounted thereon, FIG. 7 also illustrating that different sizes of drawers may be mounted in the cart;

FIG. 8 is a front view of the medication cart with portions thereof cut away to more fully illustrate the invention;

FIG. 9 is a partial sectional view illustrating the manner in which the receptacles may be mounted to the cart;

FIG. 10 is a top view illustrating the manner in which the posts may be grasped and move the cart in a first direction; and

FIG. 11 illustrates the manner in which the cart may also be grasped to move the cart in a second direction.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The medication cart of this invention is referred to generally by the reference numeral 10 and includes a cabinet or housing 12 having an upper end 14 and a lower end 16. Housing 12 includes a front portion 18, back portion 20, left side portion 22, right side portion 24, wheeled base portion 26 including wheels 27, and a countertop 28 with a recessed portion or area 30.

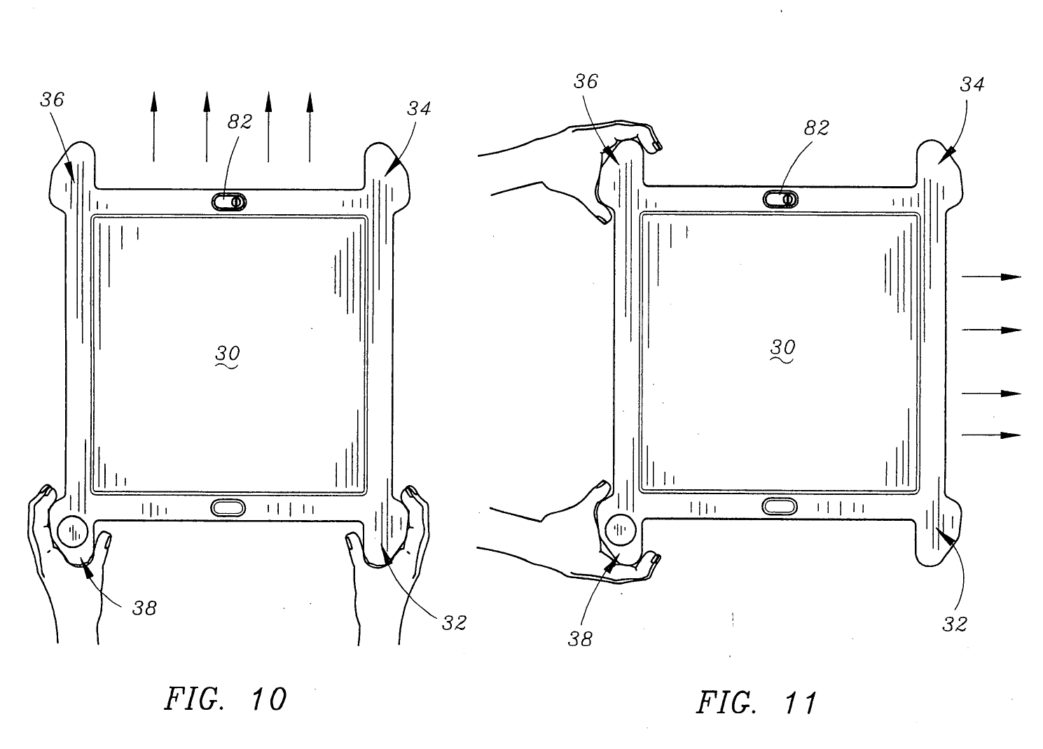

Housing 12 also includes a first upstanding post 32, a second upstanding post 34, a third upstanding post 36 and a fourth upstanding post 38 at the corners thereof. Posts 32, 34, 36 and 38 are hollow and have a unique shape as illustrated in the drawings. The unique shape of the posts 32, 34, 36 and 38 provide gripping portions 40, 42, 44 and 46 at the upper ends thereof respectively which are ergonomically designed so that a person may easily grasp the posts as illustrated in FIGS. 10 and 11 to easily maneuver the cart 10 in different directions.

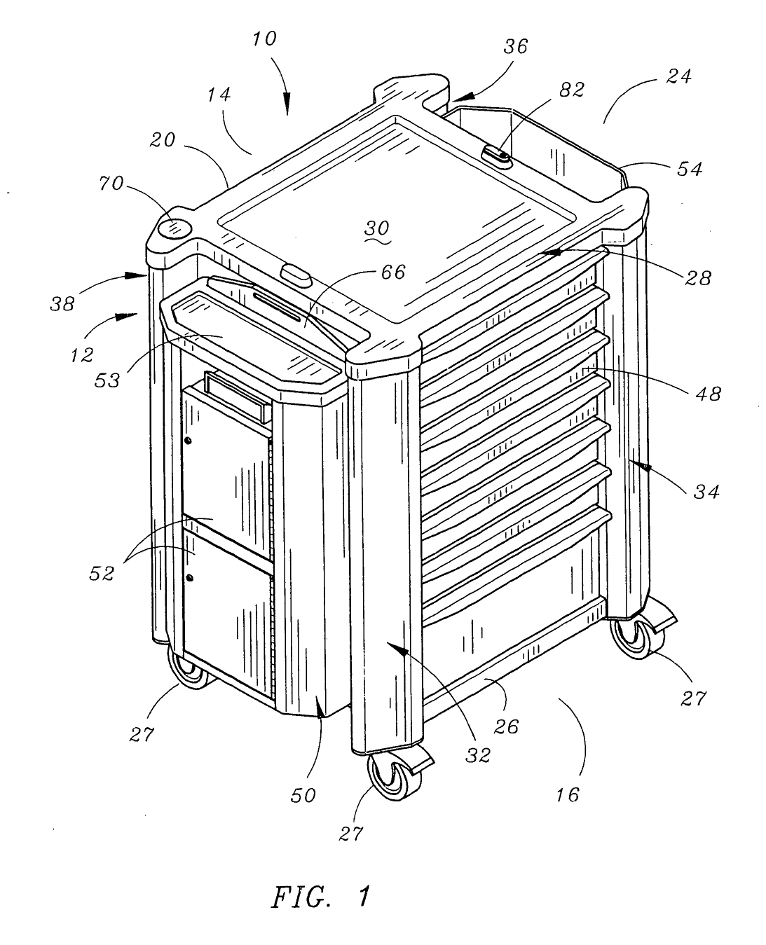

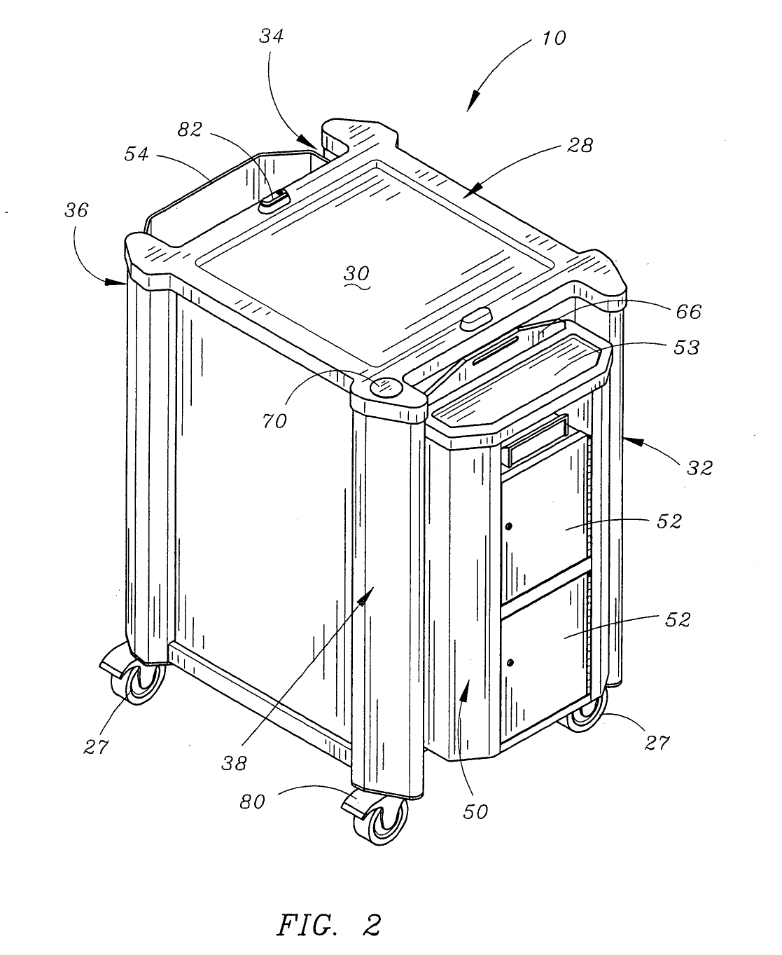

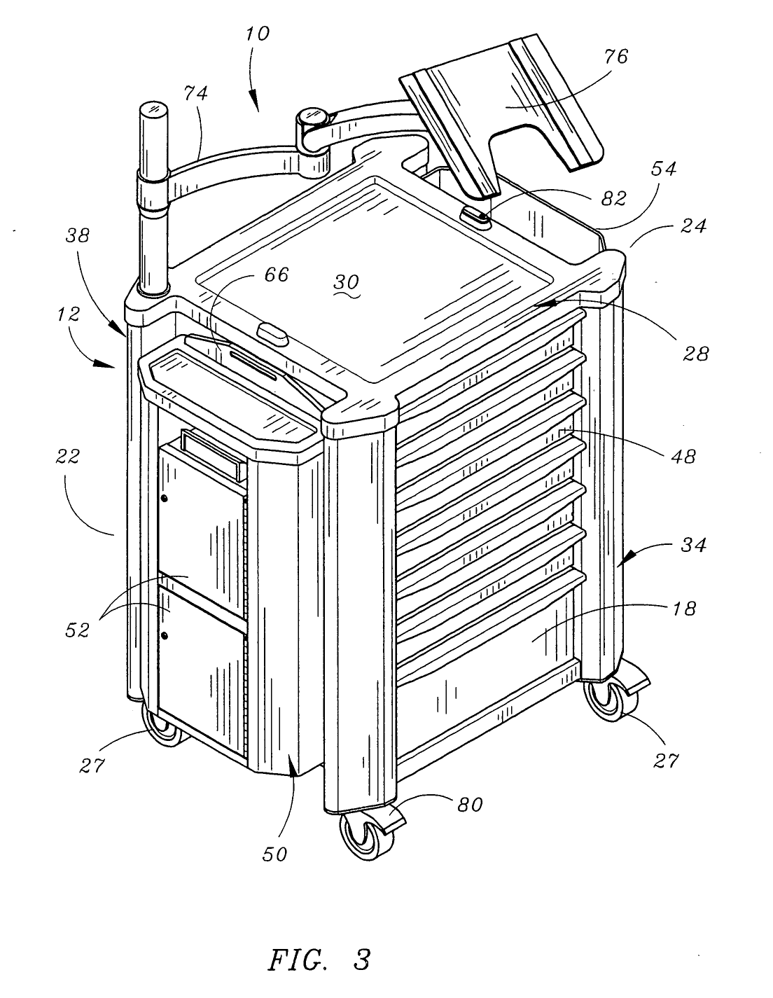

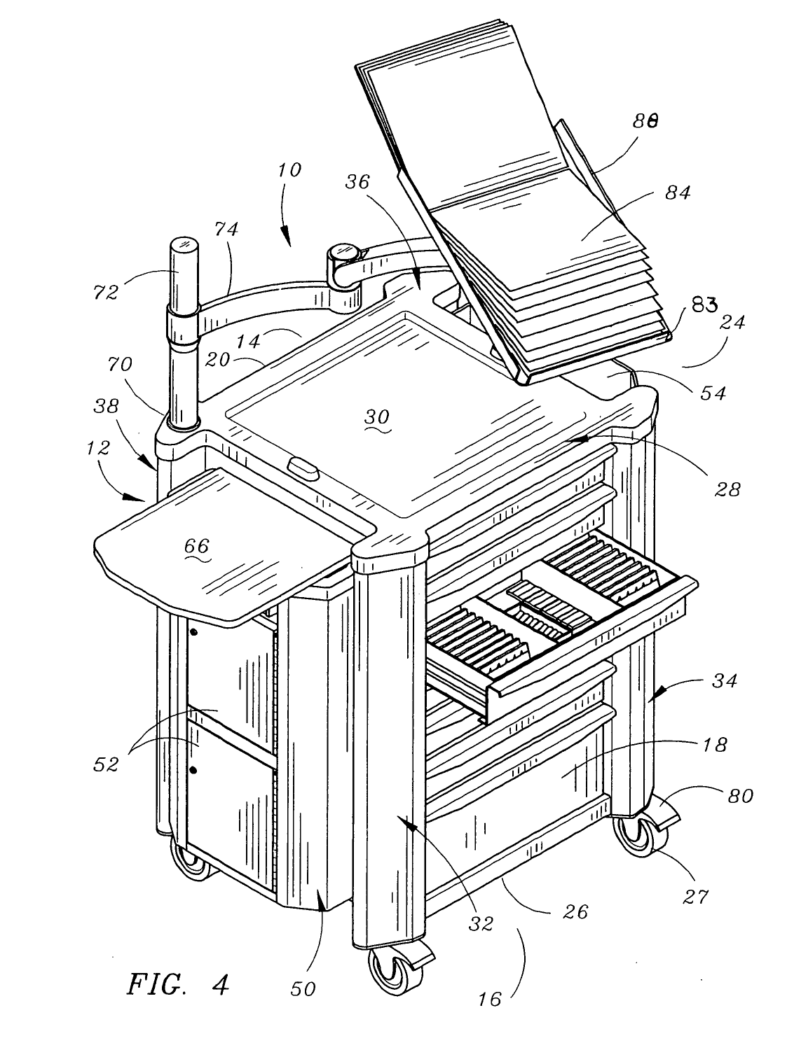

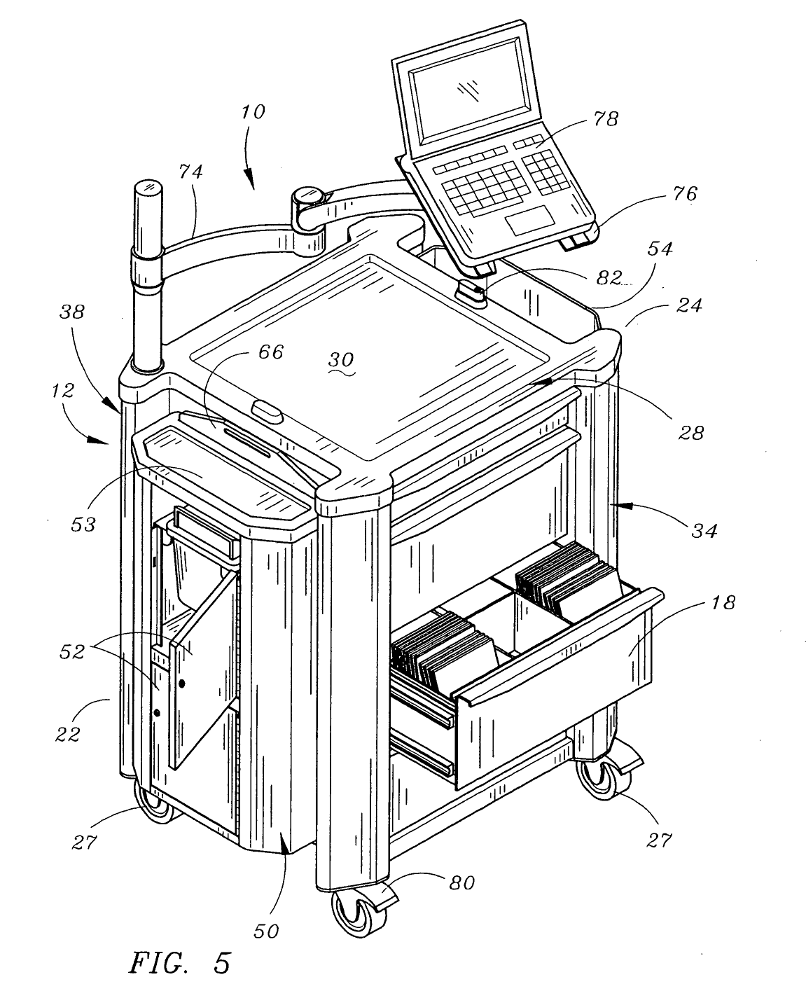

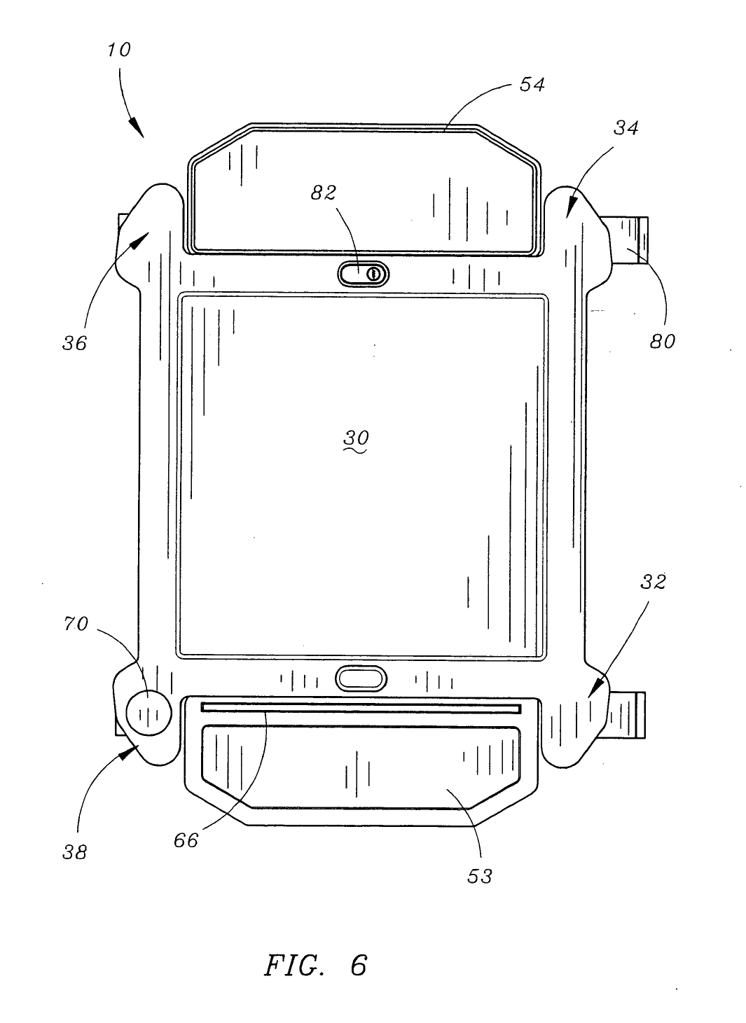

The numeral 48 refers to drawers which may be of different sizes as illustrated in FIGS. 1 and 5 and which are slidably moved with respect to the housing 12 from a closed position beneath the countertop 28 to an open position as illustrated in FIG. 4.

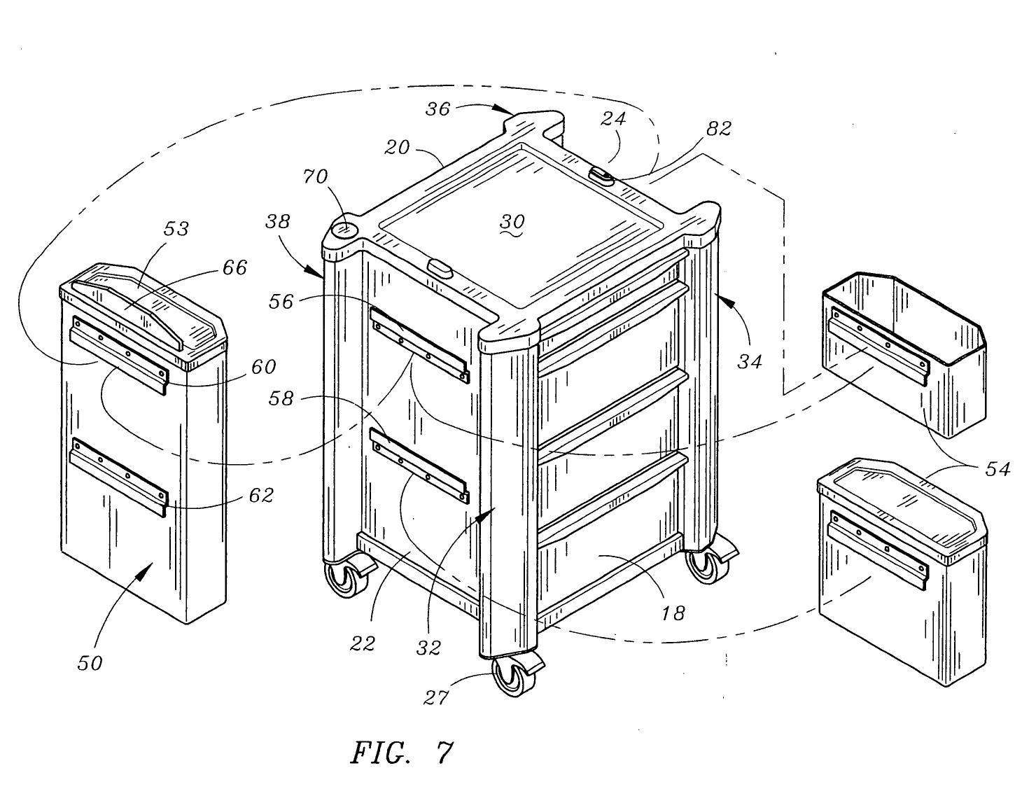

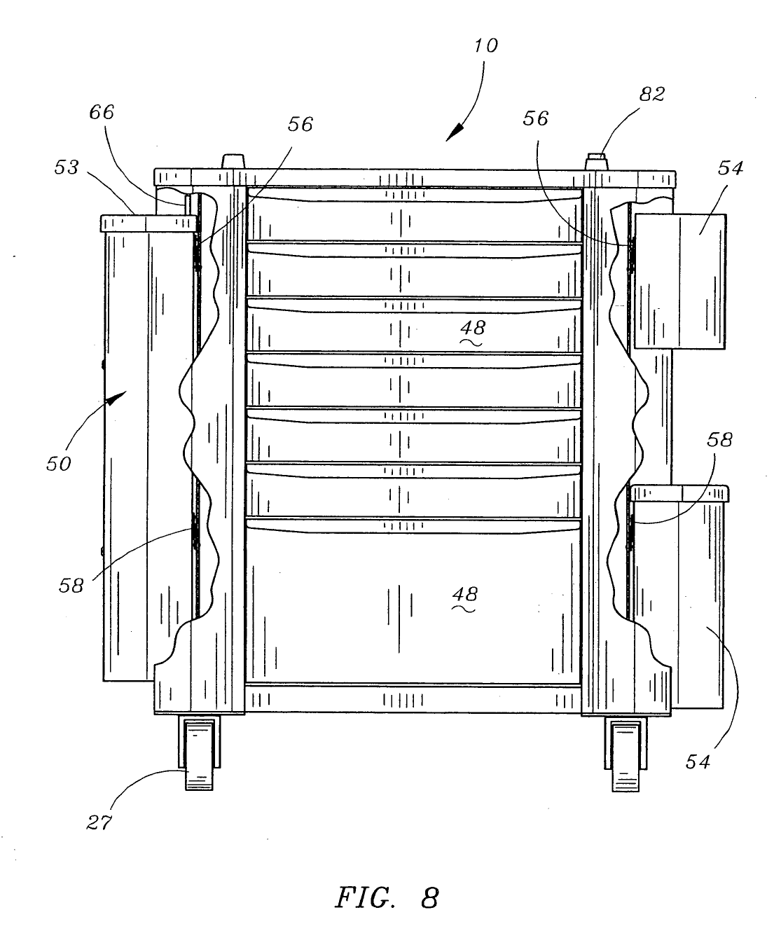

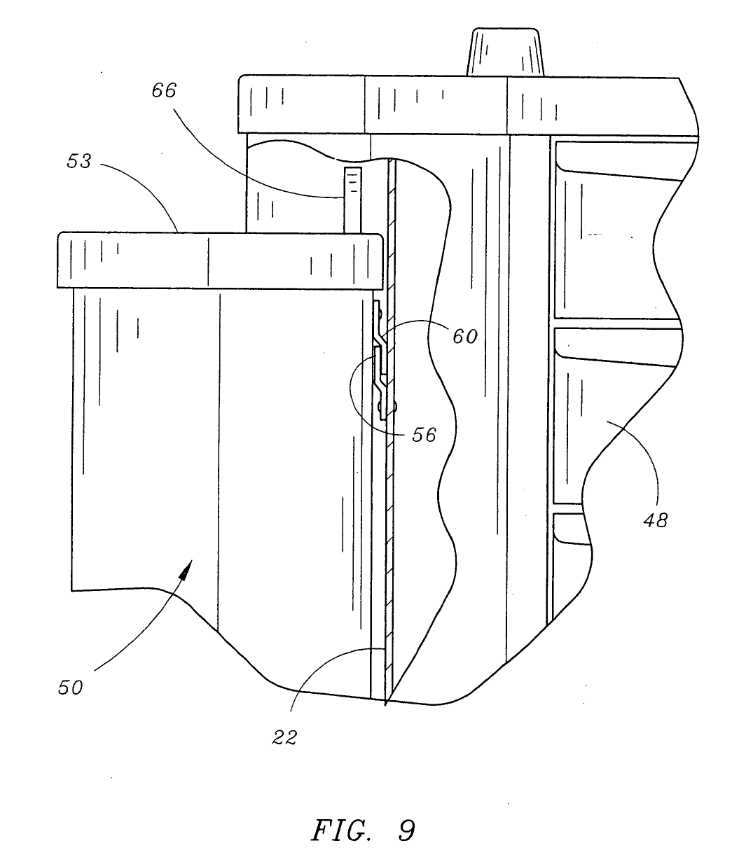

The numeral 50 refers to a receptacle mount which is selectively removably secured to the left side portion 22 of housing 12 and which has one or more receptacle components therein such as a sharps container or the like. As seen in drawings, the front portion of the receptacle mount 50 has a pair of doors 52 which are lockable. One or more trash receptacles 54 are detachably secured to the right side portion 24. As seen in FIG. 7, the left side portion 22 is provided with a pair of vertically disposed angle brackets 56 and 58 which are adapted to releasably receive the angle brackets 60 and 62 of the receptacle mount 50. If desired, the trash receptacles 54 may be either secured to right side portion 24 or the left side portion 22. Preferably, the upper end of receptacle mount 50 has a supporting surface 64 provided thereon. The numeral 66 refers to a support tray or auxiliary countertop which is selectively movably mounted on mount 50 from the stowed position illustrated in FIG. 7 to the operative position in FIG. 4. When in its operative position, tray 66 rests upon the surface 53 of mount 50 to lend support to the tray 66 with the tray 66 providing additional work surface space or countertop space.

Preferably, post 38 has an opening 70 formed therein which receives a support post 72 therein with the upper end of post 72 being positioned above the upper end of the housing 12. Support arm assembly 74 is selectively movably mounted on the support post 72 so that file/computer support plate 76 may be selectively movably positioned with respect to the housing. Support plate 76 can support a laptop computer 78 or a file tray 88 which has an upstanding lower lip 83 so that the files 84 thereon will not slip therefrom.

Preferably the wheels 27 of the cart have brakes 80 thereon. Preferably, the drawers 48 may be locked in their closed position by means of a conventional lock assembly 82.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A medication cart, comprising:
an upstanding housing having upper and lower ends and including a wheeled base portion, a front portion, a back portion, a right side portion, a left side portion, and a generally horizontally disposed countertop portion;
said housing having a first upstanding post at the juncture of said left side portion and said front portion, a second upstanding post at the juncture of said front portion and said right side portion, a third upstanding post at the juncture of said right side portion and said back portion, and a fourth upstanding post at the juncture of said back portion and said left side portion;
said first, second, third and fourth posts having upper ends;
said upper ends of said posts defining hand gripping portions which enable a person to grasp one or two of said gripping portions to maneuver the housing;
said front portion of said housing having a plurality of selectively movable medication drawers positioned thereon which are slidably movable from a closed position beneath said countertop portion to an open position.

2. The medication cart of claim 1 wherein one of said right side and left side portions have one or more receptacles provided thereon.

3. The medication cart of claim 2 wherein said receptacles are lockable.

4. The medication cart of claim 2 wherein one of said receptacles is a lockable sharps container.

5. The medication cart of claim 2 wherein the other of said right side and left side portions has one or more trash receptacles selectively removably mounted thereon.

6. The medication cart of claim 1 wherein said posts protrude outwardly from said housing.

7. The medication cart of claim 6 wherein said posts are hollow.

8. The medication cart of claim 7 wherein one of said posts has an upstanding support post mounted therein, said support post having an upper end positioned above said housing, a pivotal support arm assembly operatively pivotally secured to said upper end of said support post, and a file or computer support secured to said support arm for supporting files above said housing.

9. The medication cart of claim 1 wherein a support tray is selectively movably mounted at one of said right and left side portions, said support tray being selectively movable between a vertically disposed stowed position and a horizontally disposed operative position.

10. The medication cart of claim 9 further including means which supports said support tray when in its said operative position.

11. The medication cart of claim 1 further including wheel brakes.

12. The medication cart of claim 2 wherein said receptacles are positioned between and partially embraced by a pair of said posts.

13. The medication cart of claim 5 wherein said trash receptacles are positioned between and partially embraced by a pair of said posts.
